(19) United States
(12) Patent Application Publication
(10) Pub. No.: US 2021/0129770 A1
(43) Pub. Date: May 6, 2021

(54) AUTOMOTIVE TRIM PIECE WITH INTUITIVE SMART SWITCHES LOCATED UNDER THE AUTOMOTIVE SOFT TRIM SKIN

(71) Applicant: Inteva Products, LLC, Troy, MI (US)

(72) Inventors: Tyler R. Bame, Clawson, MI (US); Aidano Nascimento, JR., Oakland, MI (US); Michael Kobylinski, Roseville, MI (US); David Whitehead, Rochester Hills, MI (US)

(21) Appl. No.: 17/151,137

(22) Filed: Jan. 16, 2021

Related U.S. Application Data
(63) Continuation of application No. PCT/US2019/041812, filed on Jul. 15, 2019.
(60) Provisional application No. 62/698,620, filed on Jul. 16, 2018.

(51) Int. Cl. B60R 13/02; B60J 5/04; B60Q 3/233

(52) U.S. Cl. CPC B60R 13/0243; B60R 2013/0287; B60Q 3/233; B60J 5/0493

(57) ABSTRACT

A vehicle door trim interior is disclosed herein. The vehicle door trim interior has an armrest; a surface depression located in the armrest, wherein the surface depression is covered with a skin; and at least one touch sensor operably coupled to an actuator of a component of the vehicle door trim interior, wherein the at least one touch sensor is located below the skin covering the surface depression and wherein the at least one touch sensor is not visually perceivable through the skin.

### CROSS REFERENCE TO RELATED APPLICATIONS

This application claims the benefit of U.S. Provisional Patent Application No. 62/698,620 filed on Jul. 16, 2018, the entire contents of which are incorporated herein by reference thereto.

### BACKGROUND

Exemplary embodiments of the present disclosure pertain to the art of interior automotive trim pieces in combination with at least one switch operably coupled to an actuatable device of the vehicle.

Traditional vehicles have physical toggle switches in the door trim for locking/unlocking the doors and/or rolling the windows up/down. These systems can be complex and are often limited in design freedom by size and packaging space.

Accordingly, it is desirable to provide an improvement to the physical toggle switches located on a surface of the interior trim of the vehicle.

### BRIEF DESCRIPTION

Disclosed herein is a vehicle door trim interior. The vehicle door trim interior having: an armrest; a surface depression located in the armrest, wherein the surface depression is covered with a skin; and at least one touch sensor operably coupled to an actuator of a component of the vehicle door trim interior, wherein the at least one touch sensor is located below the skin covering the surface depression and wherein the at least one touch sensor is not visually perceivable through the skin.

In addition to one or more of the features described above, or as an alternative to any of the foregoing embodiments, the at least one touch sensor is located below a portion of the skin that has a symbol located thereon.

In addition to one or more of the features described above, or as an alternative to any of the foregoing embodiments, the symbol is etched or perforated in the skin.

In addition to one or more of the features described above, or as an alternative to any of the foregoing embodiments, the symbol is formed by stitching.

In addition to one or more of the features described above, or as an alternative to any of the foregoing embodiments, the symbol is formed by embroidery.

In addition to one or more of the features described above, or as an alternative to any of the foregoing embodiments, wherein at least one touch sensor is backlit.

In addition to one or more of the features described above, or as an alternative to any of the foregoing embodiments, wherein the surface depression of the armrest is located in a forward area of the armrest.

In addition to one or more of the features described above, or as an alternative to any of the foregoing embodiments, wherein the component is a window.

In addition to one or more of the features described above, or as an alternative to any of the foregoing embodiments, wherein the at least one touch sensor is a plurality of touch sensors.

Also disclosed is a vehicle trim interior. The vehicle trim interior having: a surface depression located in the vehicle trim interior, wherein the surface depression is covered with a skin; and at least one touch sensor operably coupled to an actuator of a component of the vehicle door trim interior, wherein the at least one touch sensor is located below the skin covering the surface depression and wherein the at least one touch sensor is not visually perceivable through the skin.

In addition to one or more of the features described above, or as an alternative to any of the foregoing embodiments, the at least one touch sensor is located below a portion of the skin that has a symbol located thereon.

In addition to one or more of the features described above, or as an alternative to any of the foregoing embodiments, the symbol is etched or perforated in the skin.

In addition to one or more of the features described above, or as an alternative to any of the foregoing embodiments, the symbol is formed by stitching.

In addition to one or more of the features described above, or as an alternative to any of the foregoing embodiments, the symbol is formed by embroidery.

In addition to one or more of the features described above, or as an alternative to any of the foregoing embodiments, wherein at least one touch sensor is backlit.

In addition to one or more of the features described above, or as an alternative to any of the foregoing embodiments, wherein the component is a window.

In addition to one or more of the features described above, or as an alternative to any of the foregoing embodiments, wherein the at least one touch sensor is a plurality of touch sensors.

### BRIEF DESCRIPTION OF THE DRAWINGS

The following descriptions should not be considered limiting in any way. With reference to the accompanying drawings, like elements are numbered alike:

FIG. 1 is a perspective view of a vehicle door trim interior having an armrest;

FIG. 2 is an enlarged view of an area of the vehicle door trim of FIG. 1 illustrating an area for a switch in accordance an embodiment of the present disclosure; and

FIG. 3 is a partial cross-sectional view of a switch in accordance with an embodiment of the present disclosure.

### DETAILED DESCRIPTION

A detailed description of one or more embodiments of the disclosed apparatus and method are presented herein by way of exemplification and not limitation with reference to the Figures.

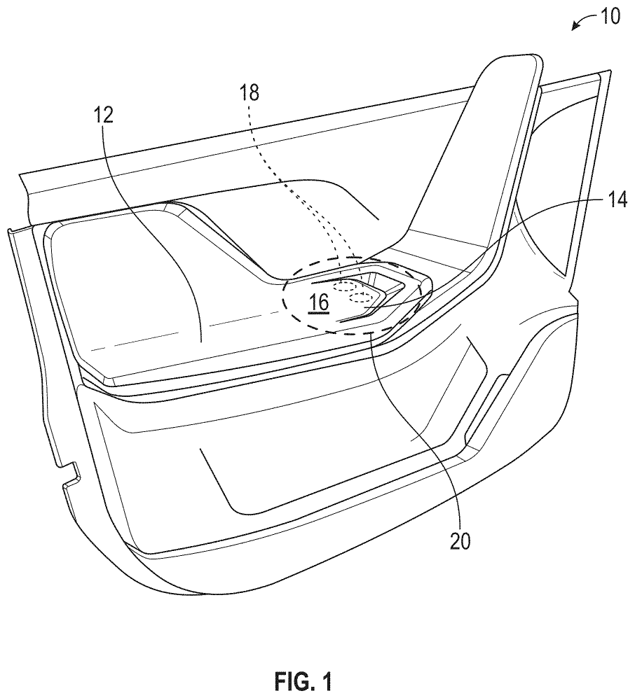

FIG. 1 illustrates a perspective view of a vehicle door trim interior 10 having an armrest 12. The armrest 12 has a small surface depression 14 about the width of three fingers in the armrest 12. Of course, other sizes (e.g., width and length) greater or less than the aforementioned width are considered to be within the scope of various embodiments of the present disclosure. The small surface depression is covered with an interior trim or show surface or skin 16 that is soft to the touch like leather or similar material. As such, this skin 16 is the final or class A surface of the vehicle interior. In other, words this material is the outer surface of the interior trim. For example and in one embodiment, the skin 16 extends over other portions of the trim including but not limited to the depression 14. One non-limiting example of such a material is a thermoplastic olefin (TPO). Underneath this layer of skin is a plurality of touch sensors 18 in various locations for activating numerous components of the vehicle for example, operation of the windows (up/down) and the vehicle latch to lock/unlock the doors. In other words, the sensors 18 are operably coupled to an actuator 22 of the components such that the sensors when activated operate as a switch 18 to operate the actuator of the components.

In one embodiment, the touch sensors 18 are located under the interior trim or show surface or skin 16 so that they are not visually perceivable. Each of these touch sensors 18 may be located underneath touch zones that are indicated by symbols that in one embodiment may be etched or perforated in the skin 18 for visual reference. In another embodiment, the symbols may be stitched or embroidered in the skin. In another embodiment, the touch sensors 18 may be backlit or illuminated to provide a means for locating the touch sensors. In another embodiment, the areas of the interior trim or show surface or skin 16 is provided with a tactile means (e.g., bump or protrusion) for locating the touch sensors 18.

In one embodiment, the touch sensors may be a capacitive switch that is actuated (e.g., closed) when the user's hand is in close proximity to the switch 18

In one embodiment, the small surface depression 14 of the armrest 12 may be referred to a smart surface interface 20. In one embodiment, the smart surface interface 20 may be located in the forward area of the door trim armrest 12 as illustrated in FIG. 1, for comfort and ergonomics.

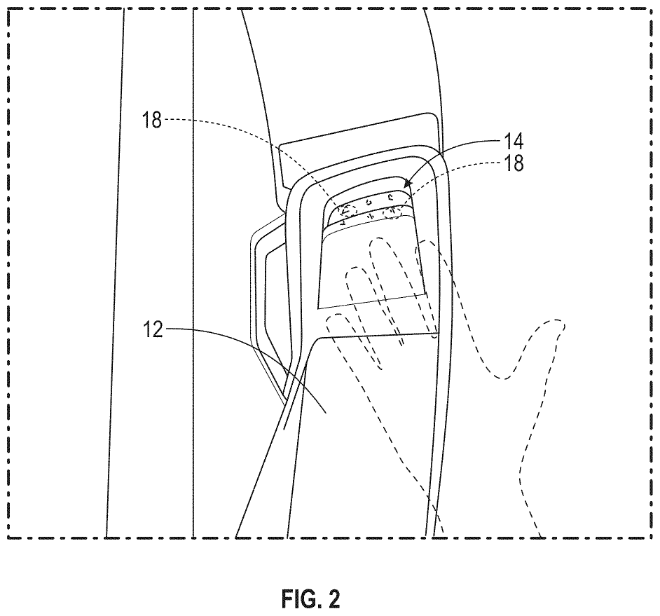

In one embodiment and as illustrated in at least FIG. 2, the indented surface 14 with the touch sensors 18 is for operating window down functions for driver/passenger side windows. Of course, other numerous vehicle functions may be operated by the aforementioned switches. As mentioned above, the switches would be located underneath the indented surface 14 in order to avoid inadvertent actuation.

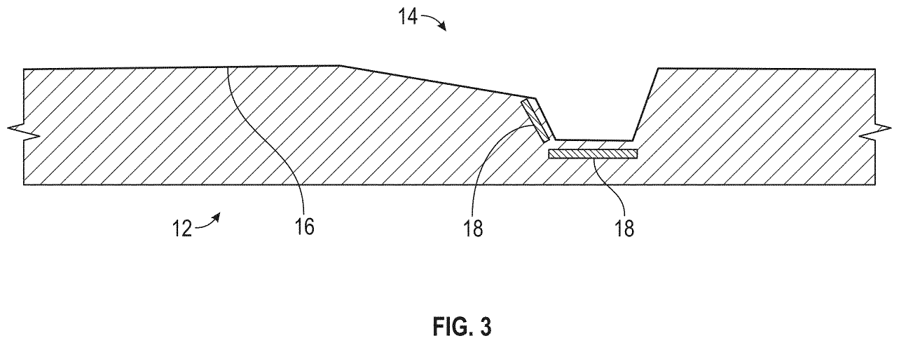

FIG. 3 is a partial cross-sectional view of a portion of the indented surface 14 in accordance with an embodiment of the present disclosure.

Although, the present disclosure illustrates the indented surface or depression 14 as being associated with an arm rest 12. This indented surface or depression 14 and its associated sensors 18 may be located in numerous other locations in the vehicle interior. Non-limiting locations include the center console, door trim panels, instrument panels or any other trim surface of the vehicle interior.

The term “about” is intended to include the degree of error associated with measurement of the particular quantity based upon the equipment available at the time of filing the application.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

Please amend/replace the claims as follows:

1. A vehicle door trim interior, comprising:
an armrest;
a surface depression located in the armrest, wherein the surface depression is covered with a skin; and
at least one touch sensor operably coupled to an actuator of a component of the vehicle door trim interior, wherein the at least one touch sensor is located below the skin covering the surface depression and wherein the at least one touch sensor is not visually perceivable through the skin.

2. The vehicle door trim interior as in claim 1, wherein the at least one touch sensor is located below a portion of the skin that has a symbol located thereon.

3. The vehicle door trim interior as in claim 2, wherein the symbol is etched or perforated in the skin.

4. The vehicle door trim interior as in claim 2, wherein the symbol is stitched or embroidered in the skin.

5. The vehicle door trim interior as in claim 1, wherein the at least one touch sensor is backlit.

6. The vehicle door trim interior as in claim 1, wherein the surface depression of the armrest is located in a forward area of the armrest.

7. The vehicle door trim interior as in claim 1, wherein the component is a window.

8. The vehicle door trim interior as in claim 1, wherein the at least one touch sensor is a plurality of touch sensors.

9. A vehicle trim interior, comprising:
a surface depression located in the vehicle trim interior, wherein the surface depression is covered with a skin; and
at least one touch sensor operably coupled to an actuator of a component of the vehicle door trim interior, wherein the at least one touch sensor is located below the skin covering the surface depression and wherein the at least one touch sensor is not visually perceivable through the skin.

10. The vehicle trim interior as in claim 9, wherein the at least one touch sensor is located below a portion of the skin that has a symbol located thereon.

11. The vehicle trim interior as in claim 10, wherein the symbol is etched or perforated in the skin.

12. The vehicle trim interior as in claim 10, wherein the symbol is stitched or embroidered in the skin.

13. The vehicle trim interior as in claim 9, wherein the at least one touch sensor is backlit.

14. The vehicle trim interior as in claim 9, wherein the component is a window.

15. The vehicle trim interior as in claim 9, wherein the at least one touch sensor is a plurality of touch sensors.
